(19) United States
(12) Patent Application Publication
(10) Pub. No.: US 2026/0046820 A1
(43) Pub. Date: Feb. 12, 2026

(54) A METHOD, APPARATUS AND COMPUTER PROGRAM PRODUCT FOR REDUCTION OF INTERFERENCE IN LOCATION DETERMINATION

(71) Applicant: Nokia Technologies OY, Espoo (FI)

(72) Inventors: Oana-Elena BARBU, Aalborg (DK); Nuno Manuel KIILERICH PRATAS, Gistrup (DK)

(73) Assignee: Nokia Technologies OY, Espoo (FI)

(21) Appl. No.: 19/102,132

(22) PCT Filed: Aug. 22, 2022
(86) PCT No.: PCT/EP2022/073315

§ 371 Date: Feb. 7, 2025

(51) Int. Cl. H04W 64/00; H04W 24/02

(52) U.S. Cl. CPC H04W 64/00; H04W 24/02

(57) ABSTRACT

There is disclosed methods, apparatuses and computer program products for enhanced accuracy positioning. In accordance with an embodiment, the method comprises determining which one or more user equipment to use to obtain channel information about a network element; obtaining from the determined user equipment transmitted information of a network element; obtaining from the determined user equipment channel information of a propagation channel between the determined user equipment and the network element obtaining channel information of a propagation channel utilized by the network element; using the collected transmitted information and the channel information of the propagation channel between the apparatus and the network element to regenerate interfering signal of the network element; using the regenerated interfering signal to at least partially compensate the interfering signal from positioning reference signals; and performing positioning measurements using the positioning reference signals from which the interfering signal has been at least partially compensated.

### TECHNICAL FIELD

The present invention relates to apparatuses, methods and computer program products for enablement of co-occurrence of positioning and communications services via a sidelink-based collaborative service-conflict resolution scheme.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

3GPP has been developing standards for New Radio sidelink (NR SL) to facilitate a user equipment (UE) to communicate with other nearby UE(s) via direct/SL communication. Two resource allocation modes have been specified, and a SL transmitter (Tx) UE is configured with one of them to perform its NR SL transmissions. These modes are denoted as NR SL mode 1 and NR SL mode 2. In mode 1, a sidelink transmission resource is assigned by a network (NW) to the SL Tx UE, while a SL Tx UE in mode 2 autonomously selects its SL transmission resources.

NR positioning is based on the use of a location server. The location server collects and distributes information related to positioning to the other entities which take part of the positioning procedures. The distributed information may comprise information of UE capabilities, assistance data, measurements, position estimates and so on.

In a downlink (DL) based positioning a reference signal called as a positioning reference signal (PRS) can be used. A user equipment may receive positioning reference signals from a plurality of distinct base station and measure a time of arrival (ToA) of the received positioning reference positioning reference signals. The UE can then report the ToA differences to a location server. The location server can use the reports to determine the position of the UE.

The PRS signal sent by a gNB is orthogonalized in time-frequency and code with other PRS signals i.e., PRS signals sent by different gNBs. The PRS signal sent by a gNB is also orthogonalized in time-frequency and code with synchronization signal blocks (SSBs) sent by the same gNB. However, this does not prevent the PRS of a serving gNB and data and/or control from different gNBs (henceforth called foreign channels) to use the same PRBs and cause co-channel interference at a target UE as depicted in FIG. 6. Here, the PRS from a far-away transmission reception point (TRP) (the gNB 601 in FIG. 6) are being interfered by the much stronger SSBs sent by a closer gNB (the gNB 602). This near-far problem may cause that the target UE fails to decode the PRS and to compute reliable positioning measurements. Ultimately, this situation may result in inaccurate position estimates. Such interfering channel may also be called as an aggressor or an aggressor channel.

### SUMMARY

There is provided a method, apparatus and computer program product for enhanced accuracy positioning. There are disclosed several methods for a target UE through which the target UE may learn and compensate for pollution (disturbances) caused by an aggressor transmitter to the positioning signals. To do that, the target UE is using a channel information (CI) and aggressor's transmitted information (TI) collected by neighbor UEs. For example, in the case of aggressor synchronization signal burst (SSB) this corresponds to a primary synchronization signal (PSS) and a secondary synchronization signal (SSS) and physical shared broadcast channel (PSBCH) content. The channel information is understood as including at least one of the following: decoded signals (e.g. the SSB's detected PSS, SSS and PDBCH (physical downlink broadcast channel) payload) and/or the channel state information related to those signals (e.g. the channel impulse response associated with the reception of the SSBs) and/or information about how the signal is delayed and rotated by the reflectors in the field and/or information about how the signal is attenuated with the distance. The PSS and SSS can be used to reveal a physical cell identity N_{ID}^{CELL}. It should be noted that the collected CI can be implicit (e.g. the aggressor signal samples as collected by the neighbor) or explicit (e.g. the aggressor propagation channel as seen by the neighbor).

According to some embodiments the method comprises regenerating and compensating for the aggressors'behavior as expected by the target UE at the own location of the target UE, during current PRS reception, using TI and CIs of the detected aggressors collected in the surroundings of the target UE, i.e. at neighboring locations in the recent past.

According to an embodiment, to overcome the shortcomings of the above solutions, a target UE generates a model of behavior of an aggressor and remove its contribution from the PRS, after which the positioning measurements can be collected. The aggressor behavior is modelled with a help of a neighbor UE, e.g. by corroborating information provided to the target UE from neighboring devices.

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to some aspects, there is provided the subject matter of the independent claims. Some further aspects are defined in the dependent claims. The embodiments that do not fall under the scope of the claims are to be interpreted as examples useful for understanding the disclosure.

This invention enables co-occurrence of positioning and communications services via a SL-based collaborative service-conflict resolution scheme.

According to a first aspect there is provided an apparatus comprising:
at least one processor; and
at least one memory storing instructions that, when executed by the at least one processor, cause the apparatus at least to:
determine which one or more user equipment to use to obtain channel information about a network element;
obtain from the determined user equipment transmitted information of a network element;
obtain from the determined user equipment channel information of a propagation channel between the determined user equipment and the network element;
obtain channel information of a propagation channel between the apparatus and the network element;
use the collected transmitted information and the channel information of the propagation channel between the apparatus and the network element to regenerate interfering signal of the network element observed by the apparatus;
use the regenerated interfering signal to at least partially compensate the interfering signal from positioning reference signals; and
perform positioning measurements using the positioning reference signals from which the interfering signal has been at least partially compensated.

According to a second aspect there is provided a method, comprising:
determining which one or more user equipment to use to obtain channel information about a network element;
obtaining from the determined user equipment transmitted information of a network element;
obtaining from the determined user equipment channel information of a propagation channel between the determined user equipment and the network element;
obtaining channel information of a propagation channel between the apparatus and the network element;
using the collected transmitted information and the channel information of the propagation channel between the apparatus and the network element to regenerate interfering signal of the network element observed by the apparatus;
using the regenerated interfering signal to at least partially compensate the interfering signal from positioning reference signals; and
performing positioning measurements using the positioning reference signals from which the interfering signal has been at least partially compensated.

According to a third aspect there is provided n apparatus comprising:
means for determining which one or more user equipment to use to obtain channel information about a network element;
means for obtaining from the determined user equipment transmitted information of a network element;
means for obtaining from the determined user equipment channel information of a propagation channel between the determined user equipment and the network element;
means for obtaining channel information of a propagation channel between the apparatus and the network element;
means for using the collected transmitted information and the channel information of the propagation channel between the apparatus and the network element to regenerate interfering signal of the network element observed by the apparatus;
means for using the regenerated interfering signal to at least partially compensate the interfering signal from positioning reference signals; and
means for performing positioning measurements using the positioning reference signals from which the interfering signal has been at least partially compensated.

According to a fourth aspect there is provided a computer program comprising instructions which, when executed by an apparatus, cause the apparatus to perform at least the following:
determining which one or more user equipment to use to obtain channel information about a network element;
obtaining from the determined user equipment transmitted information of a network element;
obtaining from the determined user equipment channel information of a propagation channel between the determined user equipment and the network element;
obtaining channel information of a propagation channel between the apparatus and the network element;
using the collected transmitted information and the channel information of the propagation channel between the apparatus and the network element to regenerate interfering signal of the network element observed by the apparatus;
using the regenerated interfering signal to at least partially compensate the interfering signal from positioning reference signals; and
performing positioning measurements using the positioning reference signals from which the interfering signal has been at least partially compensated.

### BRIEF DESCRIPTION OF THE DRAWINGS

For a more complete understanding of example embodiments of the present invention, reference is now made to the following descriptions taken in connection with the accompanying drawings in which:

FIG. 1 shows a part of an exemplifying wireless communications access network in accordance with at least some embodiments of the present invention;

FIG. 2 illustrates an example of a communication setup in which some embodiments may be implemented;

FIG. 3 illustrates an example of an NR SL resource allocation mode 1;

FIG. 4 illustrates an example of an NR SL resource allocation mode 2;

FIG. 5a illustrates an inter-UE coordination scenario, in which a coordinating UE is also an intended receiver of UE B's transmission; (b) The coordinating UE (UE A) is not the intended receiver of the UE B's transmission;

FIG. 5b illustrates an inter-UE coordination scenario, in which the coordinating UE is not the intended receiver of the UE B's transmission;

FIG. 6 illustrates an example of a situation in which an SSB sent by a TRP far-away from a UE is disturbed by transmission of an SSB by a TRP nearer to the UE;

FIG. 7 illustrates an example of a use case scenario, in accordance with an embodiment;

FIG. 8 is a signalling diagram in accordance with an approach;

FIG. 9 illustrates as a simplified flow diagram a principle of operations of a target UE to overcome aggressors' effects on the positioning signals, in accordance with an embodiment;

FIGS. 10a-10d illustrate as simplified flow diagrams operations of a target UE to overcome aggressors' effects on the positioning signals, in accordance with several embodiments;

FIG. 11 illustrates as a simplified flow diagram a principle of operations of a target UE to overcome aggressors' effects on the positioning signals, in accordance with another embodiment;

FIG. 12 is a flow diagram of a method, in accordance with an embodiment; and

FIG. 13 illustrates an apparatus in accordance with an embodiment.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

A radio device may be a device configured for communications on radio waves over a wireless radio link, i.e. a wireless link. The communications may comprise user traffic and/or signaling. The user traffic may comprise data, voice, video and/or audio. Examples of the wireless link comprise a point-to-point wireless link and a point-to-multipoint wireless link. The wireless link may be provided between two radio devices. It should be appreciated that the radio devices may have differences. For example, radio devices connected by a wireless link may comprise one or more of a user equipment (UE), an access node, an access point, a relay node, a user terminal and an Internet of Things (IoT) device.

A radio device may be a radio access device that is configured to serve a plurality of other radio devices, user radio devices, and give radio access to a communications system for the user radio devices. A radio device may also be a radio station serving as relay node or providing a wireless backhaul for one or more radio access nodes. Examples of the radio access devices comprise at least an access node, an access point, a base station and an (e/g)NodeB. Examples of the user radio devices comprise at least a user terminal and user equipment (UE). The radio device may be an aerial radio device and/or an extraterrestrial radio device configured to operate above the ground without a fixed installation to a specific altitude. Examples of extra-terrestrial radio devices comprise at least satellites and spacecraft that are configured for radio communications in a communications system that may comprise both terrestrial and extraterrestrial radio devices. Examples of aerial radio devices comprise at least High Altitude Platform Stations (HAPSs) and unmanned aerial vehicles (UAVs), such as drones. The radio access device may have one or more cells which the user radio devices may connect to in order to access the services of the communications system via the radio access device. The cells may comprise different sizes of cells, for example macro cells, micro cells, pico cells and femto cells. A macro cell may be a cell that is configured to provide coverage over a large coverage area in a service area of the communications system, for example in rural areas or along highways. A micro cell may be a cell that is configured to provide coverage over a smaller coverage area than the macro cell, for example in a densely populated urban area. Pico cells may be cells that are configured to provide coverage over a smaller area than the micro cells, for example in a large office, a mall or a train station. Femto cells may be cells that are configured to provide coverage over a smaller area than the femto cells, for example at homes or small offices. For example, macro cells provide coverage for user radio devices passing a city on a motorway/highway and local cells, e.g. micro cells or smaller cells, provide coverage for user radio devices within the city. In another example, macro cells provide coverage for aerial radio devices and/or extraterrestrial radio devices and local cells, e.g. micro cells or smaller cells, provide coverage for the aerial radio devices and/or extraterrestrial radio devices that are located at elevated positions with respect to one or more radio access devices of the communications system. Accordingly, an aerial radio device or extraterrestrial radio device may be connected to a micro cell of a radio access device and when the aerial radio device or extraterrestrial radio device is above a certain height from the ground, the aerial radio device or extraterrestrial radio device may be switched to a macro cell, for example by a handover procedure.

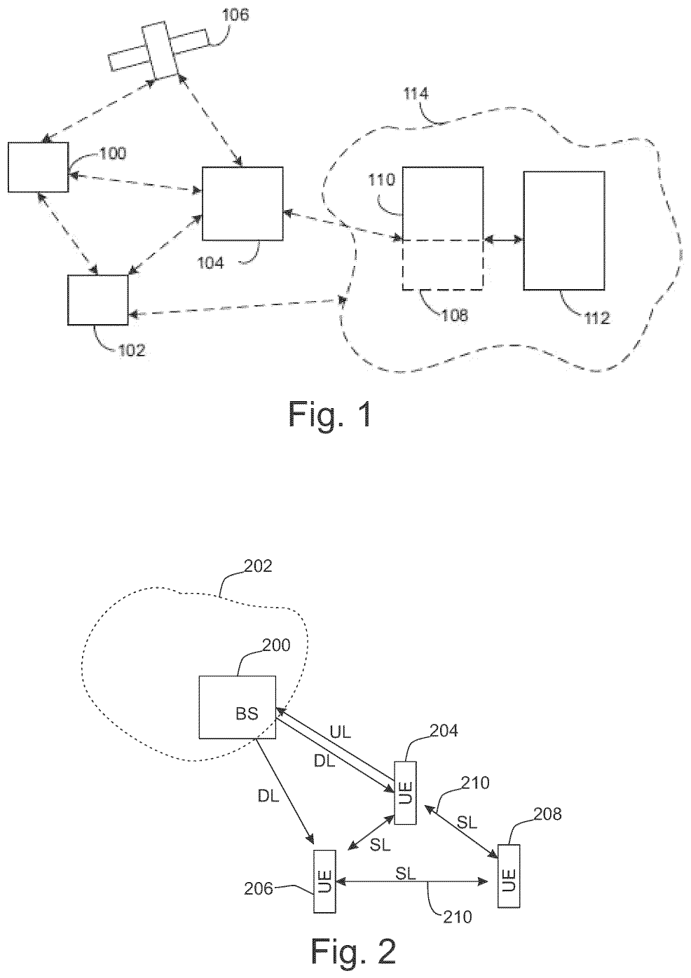

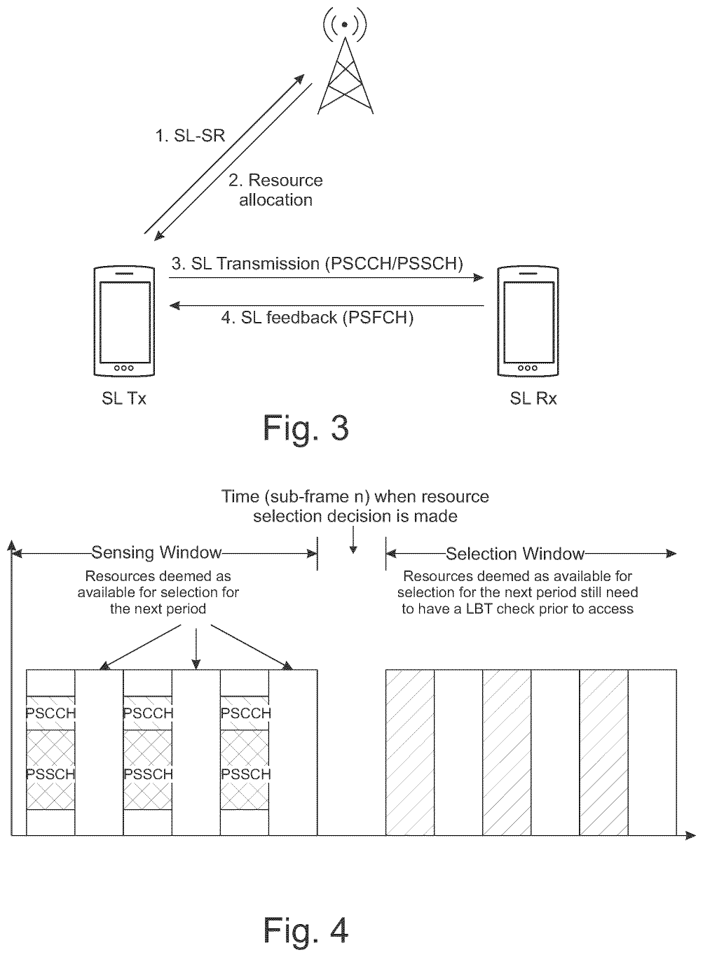

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The example of FIG. 1 shows a part of an exemplifying radio access network.

FIG. 1 shows user devices 100 and 102 configured to be in a wireless connection on one or more communication channels in a cell with an access node (such as (e/g)NodeB, which may also be abbreviated as eNB/gNB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage. The access node provides access by way of communications of radio frequency (RF) signals and may be referred to a radio access node. It should be appreciated that the radio access network may comprise more than one access nodes, whereby a handover of a wireless connection of the user device from one cell of one access node, e.g. a source cell of a source access node, to another cell of another node, e.g. a target cell of a target access node, may be performed.

The communication channels for wireless connection may also be called as wireless communication channels implemented by way of radio frequency signals, also called as radio channels.

A communication system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, wireless device, communications device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IOT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, an operations and maintenance manager, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or NodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

The embodiments are not, however, restricted to the system given as an example but a person skilled in the art may apply the solution to other communication systems provided with necessary properties.

The nature of the sidelink (SL) is oriented according to a transmitting user equipment (Tx UE) wherein a receiving user equipment (Rx UE) may need to keep monitoring all possible PSCCH (Physical Sidelink Control Channel) instances to receive sidelink transmission over one or more preconfigured resource pool(s). There are at least the following two allocation modes for sidelink transmissions. The first mode, Mode 1, is a base station (BS) scheduled mode in which the serving base station allocates resources for the user equipment for sidelink transmission, and the second mode, Mode 2, is an autonomous UE selected mode, in which the user equipment may allocate resources for the sidelink transmission without base station intervention. These modes, which may also be denoted as NR SL mode 1 and NR SL mode 2, make no difference to a receiving user equipment Rx UE in term of receiving sidelink, regardless of whether the sidelink is for broadcast, groupcast or unicast.

The sidelink can be applied for both in-coverage and out-of-coverage situations with multi-PLMN support (Tx UE and Rx UE from different serving PLMNs).

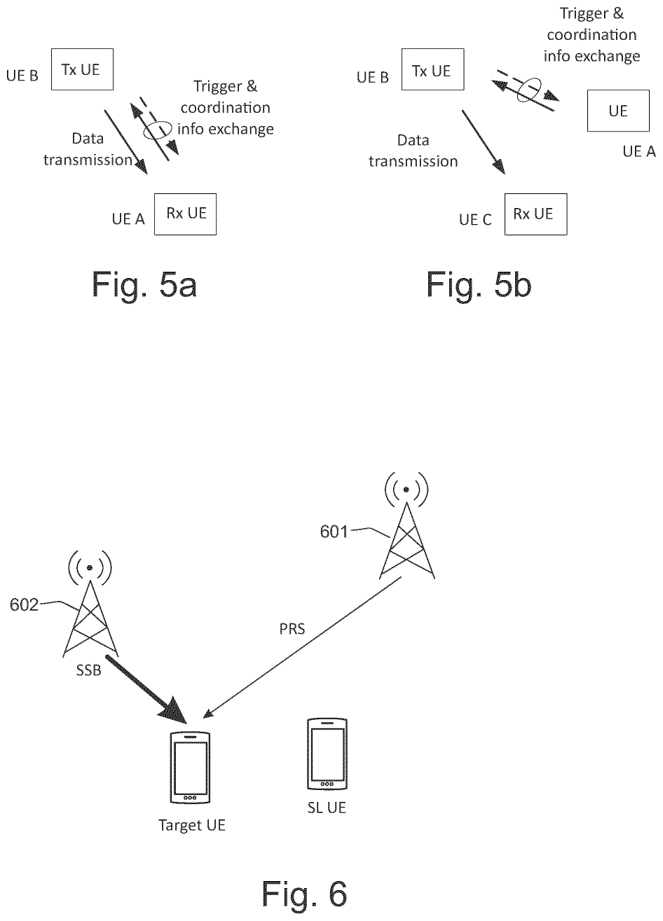

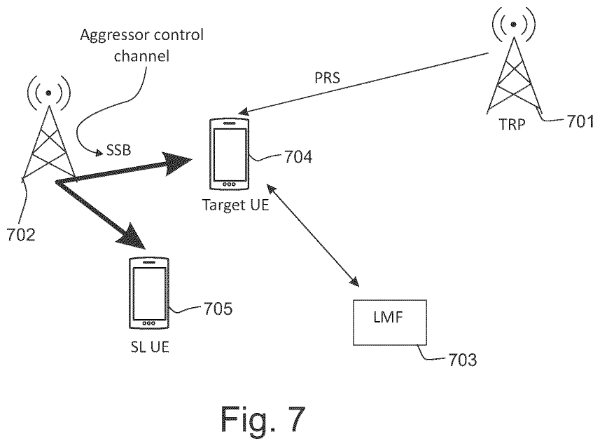

In the following, an overview of NR sidelink is shortly explained with reference to FIGS. 3 and 4, in accordance with an approach.

In mode 1, where the gNB is responsible for the SL resource allocation, the configuration and operation is similar to the one over the Uu interface, which is depicted in FIG. 3 in a simplified manner. If a first UE (SL Tx) receives information to be transmitted to a second UE (SL Rx) utilizing the sidelink transmission, the first UE sends a sidelink resource request SL-SR to the gNB. As soon as the sidelink request is authorized and if the gNB can reserve resources to the first UE, the gNB may offer resource allocation for the PSCCH and PSSCH (physical sidelink shared channel). The PSSCH carries data and the PSCCH carries control information for decoding the data channel. The gNB sends a resource allocation information to the first UE which may then use this information to initiate sidelink communication with the second UE. The first UE may then perform transmission to the second UE via the PSCCH and PSSCH. The second UE may acknowledge the received packets by sending an acknowledgement in a physical sidelink feedback channel (PSFCH) to the first UE. In some approaches the acknowledgment may only be sent when there is an error in the reception of packets from the first UE.

In mode 2, the first UE and the second UE perform sidelink establishment autonomously so that the first UE performs resource selection with the aid of a sensing procedure. More specifically, a SL Tx UE in NR SL mode 2 first performs a sensing procedure over the configured SL transmission resource pool(s), in order to obtain the knowledge of the reserved resource(s) by other nearby SL Tx UE(s). Based on the knowledge obtained from sensing, the SL Tx UE may select resource(s) from the available SL resources, accordingly. In order for a SL UE to perform sensing and obtain the necessary information to receive a SL transmission, it needs to decode the sidelink control information (SCI).

In other words, in Mode 2 the sensing operation may comprise sensing first within a sensing window, then excluding resources reserved by other UEs, and selecting final resources within a selection window. In Mode 2, shortly before transmitting in a reserved resource, the first UE re-evaluates the set of resources to check whether its intended transmission is still suitable. In this re-evaluation the first UE may consider a possible aperiodic transmission after the resource reservation. If the reserved resources would not be part of the set for selection at this time, then new resources are selected from the updated resource selection window. In addition to the re-evaluation, pre-emption is also introduced such that a UE selects new resources even after it announces the resource reservation when it observes resource collision with a higher priority transmission from another UE. This procedure is illustrated in FIG. 4, in accordance with an approach.

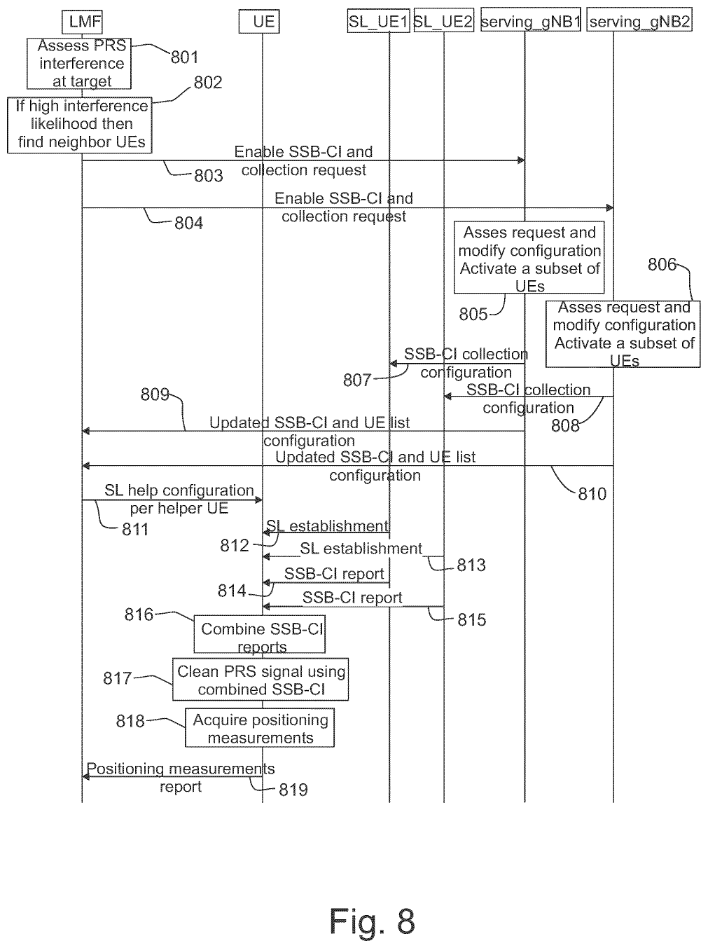

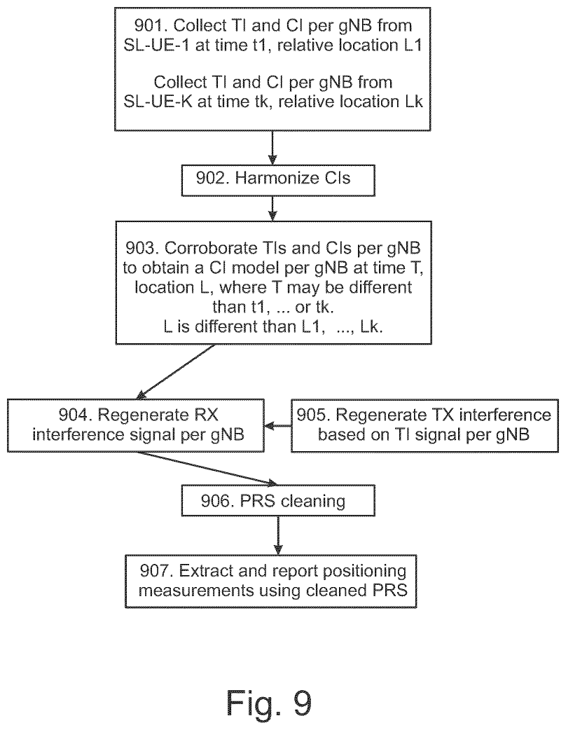

In the following, some details of an inter-UE coordination will be described with reference to FIGS. 5a and 5b, in accordance with an approach.

In the example of FIG. 5a, in which the coordinating UE (UE A) is also the intended receiver of UE B's transmission, a set of resources is determined at the UE-A. This set is sent to the UE-B in mode 2, and the UE-B takes this into account in the resource selection for its own transmission. The solution may be able to operate in-coverage, partial coverage, and out-of-coverage and to address consecutive packet loss in all coverage scenarios.

In one of the inter-UE coordination scenarios in which the coordinating UE (UE A) is not the intended receiver of the UE B's transmission, depicted in FIG. 5b, the UE A (Rx-UE) selects the preferred SL transmit resource(s) (e.g., according to results of its sensing procedure) and recommends the selected resource(s) to UE B (Tx-UE), where the UE B selects its SL transmit resource by taking into account the resource(s) indicated by the UE A and in addition performing its own sensing, e.g., the UE B may use or may not use the recommended resource(s) to transmit to the UE A. Thus, by using the inter-UE coordination scheme, the UE A may try to ensure there is no packet collision or strong interference over its selected resource(s) and, thus, the transmission from the UE B to the UE A can occur with high(er) reliability.

In another Inter-UE coordination scenario (denoted in 3GPP as inter-UE Coordination Scheme 2), the UE A monitors the transmissions taking place in the SL resource pool and every time a collision or half-duplex problem is detected, either in the past or in future resources, and then the UE A informs the impacted UEs.

As was mentioned earlier in this specification, the near-far problem may cause the target UE to fail to decode the positioning reference signals and to compute reliable positioning measurements possibly resulting in inaccurate position estimates. One straightforward solution would be to orthogonalize positioning reference signals with respect to foreign control signals like synchronization signal blocks (or in the extreme case all other data signals). However, this solution is unscalable, for two main reasons. First, a single target UE needs to periodically receive positioning reference signals from multiple sources, such as from both a serving and a non-serving cell, and such solution would ultimately result in reserving most, if not all the available spectrum for positioning purposes only. Second, increased network densification means high likelihood that other nearby UEs need to be served while performing positioning of the target UE.

A much more computationally expensive solution would be for the target UE to attempt to decode and cancel the interference coming from the SSBs, prior to decoding the PRS. Such approach is not suitable for latency sensitive positioning and/or limited-power UEs which are typically not equipped with positioning receivers capable of advanced interference estimation and/or cancellation.

In the following, an example of a collaborative framework among neighbour devices will be described, which may be utilized in a system and method aiming to overcome the shortcomings of the above solutions. The framework allows coexistence of positioning and communication applications in the same spectrum without relying on advanced positioning receiver capabilities at the target UE side.

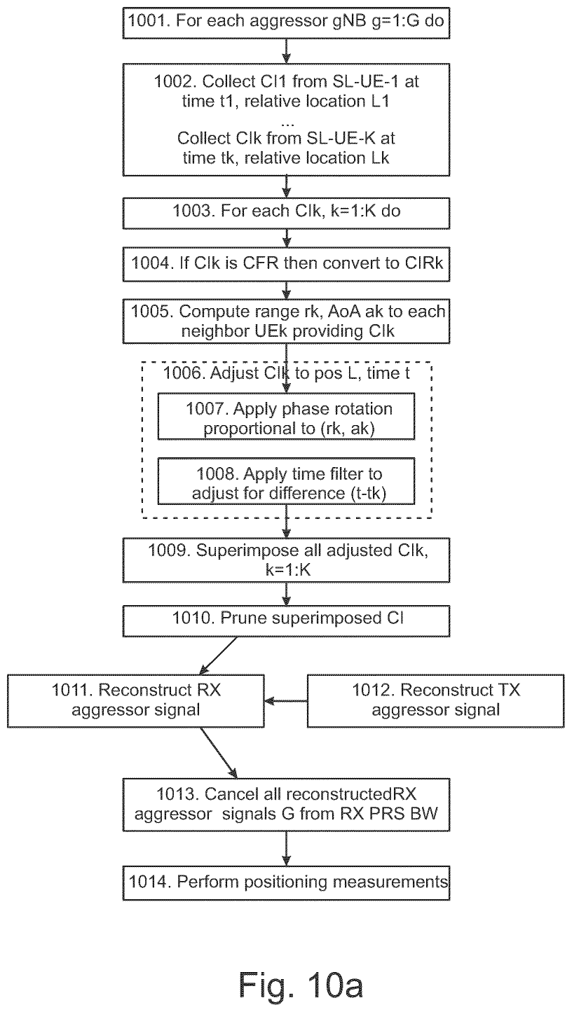

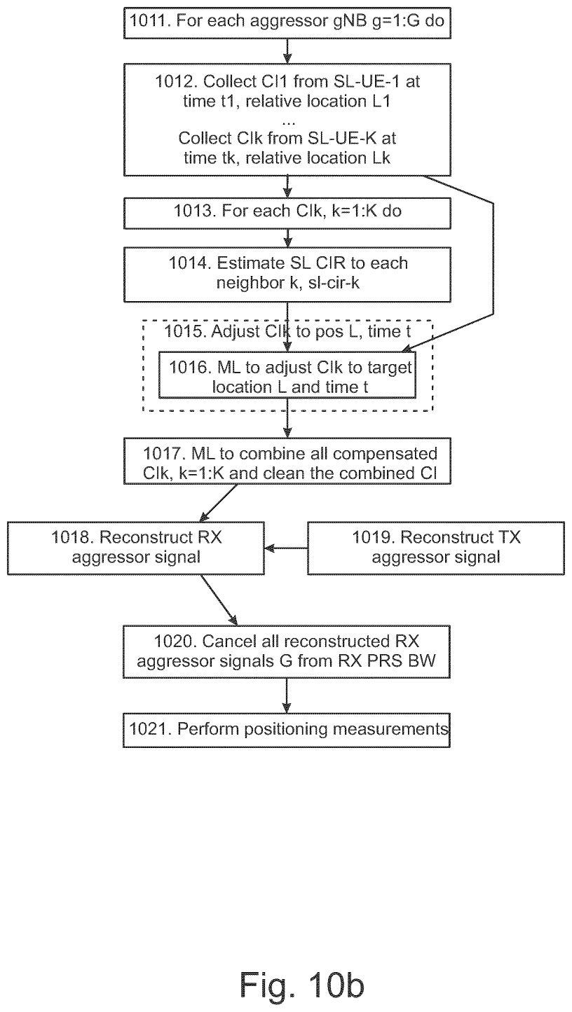

An example scenario is depicted in FIG. 7. and an example of signalling is depicted in FIG. 8, in accordance with an embodiment. The target UE 704 is triggered at a first time instant t1 to perform downlink positioning. Since the positioning reference signals from the transmission reception point (TRP) gNB 701 are interfered by the much stronger synchronization signal blocks (SSB) from the other gNB 702, which is closer to the target UE 704 than the gNB 701, it may happen that the positioning reference signals from the transmission reception point gNB 701 cannot be successfully decoded, and the localization accuracy is compromised. To mitigate this situation, following procedure may be utilized.

A location management function (LMF) 703 receives a localization request for the target UE 704. The location management function 703 assesses (block 801 in FIG. 8) whether the target UE 704 is likely to experience positioning interference. For example, based on serving cell/beam information, the LMF 703 may be able to find out a coarse location of the target UE 704. This coarse location may be or may have been associated with high levels of heterogeneous interference as reported by other past/current target UEs, e.g. by the UE 705, or flagged by one or more gNBs via explicit NR positioning protocol A (NRPPa) messaging triggered by an LMF request.

Based on a result of the levels of heterogeneous interference reported by other past and/or current target UEs or flagged by one or more gNBs, the location management function 703 identifies what channels are causing the interference. Such channel is called in this specification as an aggressor channel.

If the outcome of the identification is positive, i.e. interference by one/more foreign control channels is likely, the location management function 703 identifies 802 one or more nearby neighbor UEs that are actively monitoring the channel(s) deemed as aggressors for their own radio resource management (RRM) purposes i.e. estimate channel conditions towards the aggressor channel(s) e.g. by estimating propagation conditions of the aggressor channels i.e. wireless channels. An example of a nearby UE is the SL-UE 705 in FIG. 7. Such a neighbor UE may be defined as a UE that shares the same serving beam index, cell sector, etc.

The location management function 703 requests 803 the gNB (serving_gNB1 in the example of FIG. 8), which is serving the one or more SL-UEs, to enable the UE served by this gNB (SL_UE1) to record and share the aggressor control channel information (SSB-CI) to the target UE. Such SSB-CI may refer to channel frequency response (CFR), impulse response, main path gain and delay, etc.

In the example of FIG. 8 the location management function 703 also requests 804 another gNB (serving_gNB2) to enable the UE served by this gNB (SL_UE2) to record and share the aggressor control channel information (SSB-CI) to the target UE.

The messages 803, 804 may contain an explicit list of neighbor UEs IDs e.g. in case that the LMF 703 has previously/recently localized them or a blanket-request for SSB-CI using the serving cell, serving beam index of the target UE. This means that the gNBs need themselves to select the helper UEs, using the target UE's information and the SSB-CI configuration request.

After the corresponding gNBs have assessed the LMF request, they use and/or modify 805, 806 the LMF parameterization and select one or more helper UEs to collect SSB-CI. Subsequently, the serving_gNB1 configures the corresponding SL sessions by sending an SSB-CI collection configuration message 807 to the SL_UE1 and, correspondingly, the serving_gNB2 configures the corresponding SL sessions by sending an SSB-CI collection configuration message 808 to the SL_UE2. The SSB-CI collection configuration messages 807, 808 indicate to the helpers (i.e. SL_UE1, SL_UE2 in the example of FIG. 8) a strategy for collecting SSB-CI e.g. duration, bandwidth part (BWP), etc. The serving_gNB1 reports modifications and SL-UEs down-selection back to the LMF via sending a message 809 to the location management function 703 and the serving_gNB2 reports corresponding modifications and SL-UEs down-selection back to the location management function 703 via sending a message 810 to the location management function 703. The location management function 703 propagates the reported modifications and SL-UEs down-selection for each selected helper UE to the target UE via a message 811. It should be noted that the impeding SL session may also be communicated to the serving gNB of the target UE, either by the location management function 703 directly (via NRPPa), or by the target UE (via RRC signalling).

Sharing the aggressor control channel information SSB-CI is realized over SL, at a time instance t2, where t2 may be immediately preceding or following the time instance t1, as determined by the location management function 703. The SL-based sharing can be realized by broadcast/groupcast messages and in this way all target UEs in the vicinity can take advantage of this information or unicast messaging where a single target UE will benefit.

The serving gNB configures SL-UE to record SSB-CI for time instances t<t1 (i.e. before the target UE 704 is triggered to perform downlink positioning), and to establish a sidelink to the target UE for sharing SSB-CI with the target UE at the time instant t2.

The location management function 703 triggers DL positioning for target UE at the time instant t1, and the target UE collects the positioning reference signal samples as instructed.

At time t2, once the messages 811, 807 and 808 have been received, the SL sessions can be deployed and started. The target UE and SL-UE1 establish 812 SL communication and the target UE receives SSB-CI from the SL_UE1. Similarly, also the target UE and SL-UE2 establish 813 SL communication and the target UE receives SSB-CI from the SL_UE2. After receiving the collected SSB_CIs from the helper UEs, i.e. SL_UE1 and SL_UE2, the target UE runs the measurements through blocks 816 and 817, before collecting its own PRS measurements (block 818).

When the target UE has performed the cleaning of the received PRS samples the target UE may perform positioning measurements and collect 818 the PRS measurements. Results of the positioning measurements may be reported 819 by the target UE to the location management function 703.

Next, a procedure the target UE may perform in blocks 816-818 is described, in accordance with an embodiment.

In the following, some embodiments related to learning and compensating by the target UE effects caused by one or more aggressor's transmitter to the positioning signals will be described in more detail. Hence, the target UE may be able to diminish or compensate or even eliminate aggressor channel effect on the positioning function. It is assumed that the target UE has readily obtained channel information (CI) and/or aggressor's transmitted information (TI) for some or each aggressor gNB from a set of nearby gNBs, possibly by using the above-described method. As was already mentioned in the Summary section, the channel information is understood as including at least one of the following: the decoded signals such as the SSB's detected PSS, SSS and PDBCH and/or the channel state information related to those signals such as the channel impulse response associated with the reception of the SSBs and/or information about how the signal is delayed and rotated by the reflectors in the field and/or information about how the signal is attenuated with the distance.

In the following embodiments the target UE is using explicit CI about all detected aggressors. Explicit CI may refer to e.g. CFR, CIR, main arrival path, etc. Implicit CI is considered a straightforward extension of the explicit case.

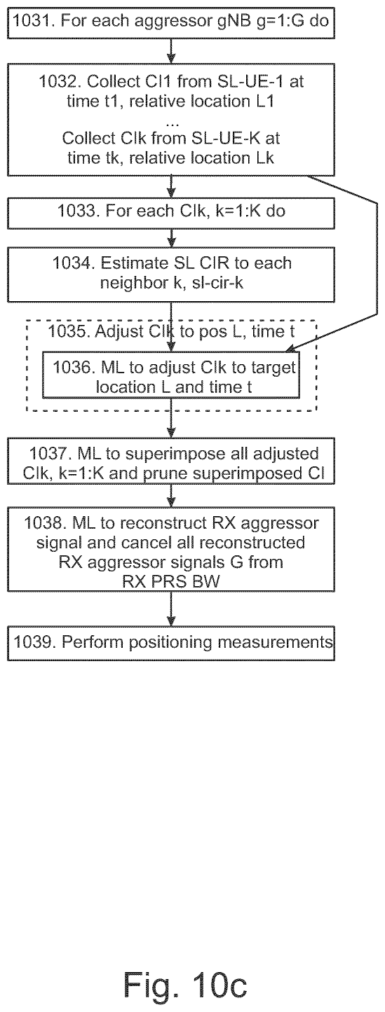

FIG. 9 illustrates as a simplified flow diagram operations of the target UE to overcome the aggressors' effects on the positioning signals.

In block 901 TI and CI per gNB are collected by the target UE from a first other UE i.e. a first sidelink UE (SL-UE-1). The TI and CI have been received by the first sidelink UE at a time instant t1. Also information of the time instant t1 will be provided to the target UE. The target UE also collects TI and CI per gNB from a second sidelink UE (SL-UE-2) and the information of the time instant t2 when the TI and CI have been received by the second sidelink UE. Similarly, the target UE collects TI and CI per gNB from possible other sidelink UEs (SL-UE-K). It should be noted that it may also happen that there is only one or two SL-UEs from which the TI and CI will be collected (i.e. k is 1 or 2, respectively).

In block 902 the target UE harmonizes the collected CIs per gNB (per aggressor) using the same CI representation for all CIs. The harmonization may be performed, for example, so that all CIs are converted to channel impulse responses (CIR) of fixed length, to channel frequency responses (CFR), etc. As an example, channel frequency responses may be converted to channel impulse responses by utilizing a discrete Fourier transform (DFT).

In block 903 the target UE corroborates each aggressors'TI and CI into a TI and CI specific to the target UE, where the corroboration accounts for the location of the neighbor UEs relative to the target UE and the time instances when the CI was collected by each neighbor, relative to the moment when the target UE collects PRS samples.

In block 905 the target UE regenerates the TX interference based on TI signal per gNB.

In block 904 the target UE regenerates the aggressors'signals as seen at the target UE based on the TI and CI specific to the target UE and obtained by the corroboration process of block 903 and the regenerated TX interference.

In block 906 the target UE may clean the PRS partly or totally using the output of block 904. The efficiency of the cleaning process may depend on how reliable the model output by the aggressor regeneration is. By partial cleaning it is meant that only a part of the aggressor's regenerated behavior (e.g., only the main regenerated path of the aggressor channel) is used to remove the interference experienced by the target UE.

In block 907 the cleaned PRS can be used to extract and report positioning measurements.

In the following, some embodiments will be described in which the target UE is using explicit CI about all aggressors. Explicit CI may refer to e.g. CFR, CIR, main arrival path, etc. Implicit CI is considered a straightforward extension of the explicit case.

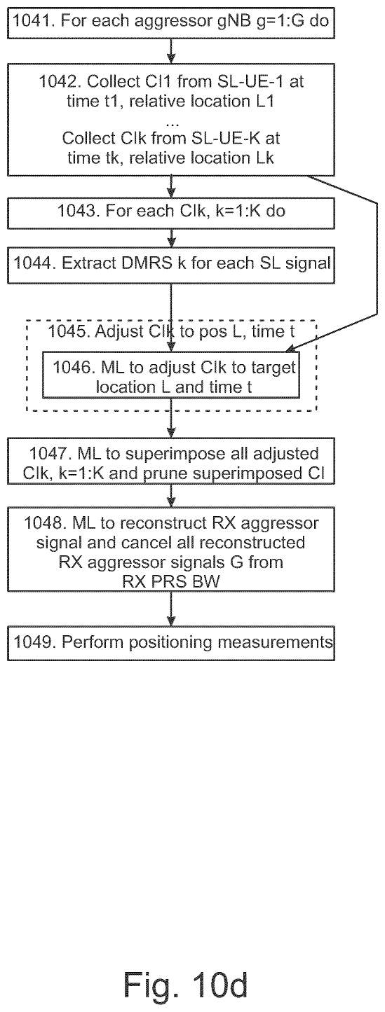

In accordance with an embodiment, illustrated in FIG. 10a as a simplified flow diagram, the target UE at location L collects (block 1002) the TI and CI for each potential aggressor g=1:G (block 1001), from all helper UEs (SL-UE-k), k=1:K. Each helper UE k is providing TI and CI as observed at time tk and at its own location Lk, where Lk is close to the target UE. A determination whether a UE is close to the target UE may depend on implementations or practical situations. For example, UEs closer than several tenths of meters, several hundreds of meters and/or several kilometers may be regarded as an appropriate helper UE if it is able to receive signals from that gNB/those gNBs that are interfering reception of positioning reference signals by the target UE i.e. is/are aggressor(s) regarding the target UE.

For each CIk, k=1:K, the target UE performs the processes of the following blocks 1004-1008.

In block 1004, the target UE harmonizes the CIs from different helper UEs, if CIs from each helper UEs are not in the same format. For example, the target UE converts CFRs to CIRs.

In block 1005, since the target and the helper are communicating over SL, the target UE can infer the relative location of UE k by assessing the SL characteristics i.e., it extracts the range rk and the angle-of-arrival (AOA) ak e.g. by using a demodulation reference signal (DMRS) for a physical sidelink shared channel (PSSCH), DMRS SL PSSCH.

In block 1006, using the range tk, angle of arrival ak and time tk related to each helper UE k, the target UE adjusts the CI reported by UE k to compensate for the relative position of the target UE and the helper UE k and the time difference between when the TI and CI was collected by the helper UE k and when it is used at the target UE, i.e. the difference between tk and t.

In block 1007 a phase rotation proportional to (rk, ak) is applied by the target UE and in block 1008 a time filter is applied by the target UE to adjust the time difference t−tk.

Following the above compensation for the location and time mismatches, the target UE combines the CIs from all helper UEs, for each aggressor. The combination may consist of superimposition (block 1009) followed by pruning (block 1010), but may consist of other operations as well such as weighted average, Wiener-filtering type of operation using a spatial multiplexing mask, etc.

Having obtained a TI and CI per (aggressor, target) pair, the target UE can now reconstruct the aggressor signal as observed at the target UE and remove its contribution from the total received signal (blocks 1011-1013). This operation may be realized for all detected aggressors.

In block 1014 the target UE extracts the required positioning measurements using the cleaned signal.

In an alternative embodiment presented in FIG. 10b, the compensation for location and time mismatches may be realized by means of supervised learning (e.g. a deep neural network DNN, a convolutional neural network CNN, etc.). Similarly, combining multiple compensated CIs may also be implemented via a neural network (NN).

As was the case in the embodiment of FIG. 10a, the target UE at location L, for each potential aggressor g=1:G (block 1011), collects (block 1012) the TI and CI from all helper UEs (SL-UE-k), k=1:K. Each helper UE k is providing TI and CI as observed at time tk and at its own location Lk, where Lk is close to the target UE.

For each CIk, k=1:K, the target UE performs the processes of the following blocks 1014-1016.

In block 1014, the target UE estimates sidelink channel impulse responses to each k nearby UEs which have been determined or selected as helper UEs. Such sidelink channel impulse responses are expressed as sl-cir-k in FIG. 10b.

In 1015 the target UE adjusts CIk to the target UE's position L and time t. This is performed by using a machine learning algorithm (ML) in this embodiment (block 1016). The ML is provided with as inputs the estimated SL CIR of each helper UE k as well as channel information CI1, . . . CIk collected from the helper UEs SL-UE-1, . . . SL-UE-k In block 1012.

The ML may use the received information to build up the learning process and utilize it also afterwards.

In block 1017 the ML is further used to combine all compensated CIk and to clean the combined CI.

Having obtained a TI and CI per (aggressor, target) pair, the target UE can now reconstruct the aggressor signal as observed at the target UE and remove its contribution from the total received signal (blocks 1018-1020). This operation may be realized for all detected aggressors.

In block 1021 the target UE extracts the required positioning measurements using the cleaned signal.

Similarly, the aggressor's signal reconstruction and cancellation may be realized via a neural network (NN) implementation as shown in block 1038 of FIG. 10c. Such a variant may be beneficial when the collected CIs are associated with low accuracy, or when the CIs for one aggressor are heterogeneous e.g. some UEs report CFR, some others report main path, etc.

The operation of the blocks 1031-1036 correspond with the operations of blocks 1011-1016 on the embodiment of FIG. 10b, respectively, so they are not repeated in this context.

In block 1037 the ML is utilized so that it uses the outcome of the block 1036, i.e. channel information CIK of the helper UEs k adjusted to the location of the target UE, and superimposes the adjusted CIK, k=1:K to obtain a superimposed CI, and prunes the superimposed CI.

In block 1038 the ML reconstructs RX aggressor signals and uses the reconstructed aggressor signal) to cancel them from the received localization signals RX PRS BW.

In block 1039 the target UE extracts the required positioning measurements using the cleaned signal.

FIG. 10d illustrates yet another embodiment. In this embodiment, the relative localization, i.e. computing rk, ak by the target UE may be bypassed altogether, and the SL DMRS may be directly fed to a supervised learning block e.g. implemented as a deep neural network, convolutional neural network, etc., which will adjust each CI to compensate for the location and time mismatches, i.e. adapt the CI obtained at location Lk, time tk, to the target location L, time t (block 1044 in FIG. 10d).

In this embodiment, the operation of the blocks 1041-1043 corresponds with the operation of blocks 1031-1033 of the embodiment of FIG. 10c, respectively, and the operation of the blocks 1045-1049 corresponds with the operation of blocks 1035-1039 of the embodiment of FIG. 10c, respectively.

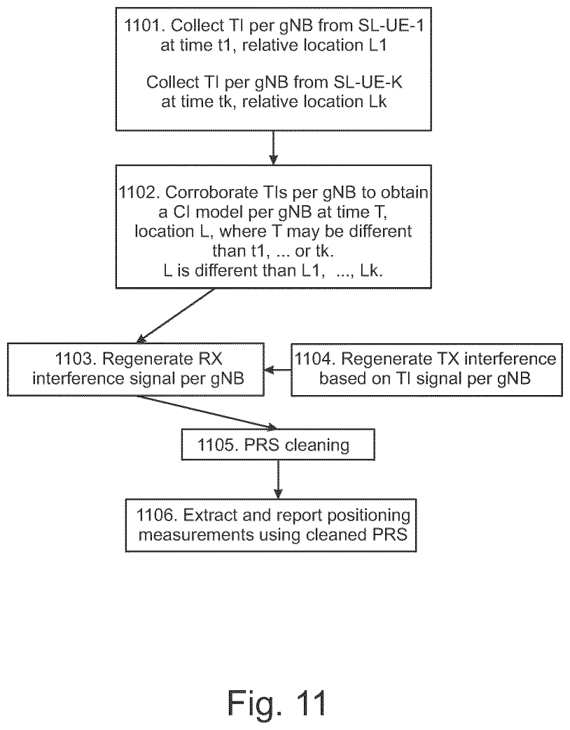

In another embodiment, illustrated in FIG. 11, the target UE may use the TI from the peer UE only and combine the TI to obtain the aggressor CI.

In block 1101 TI per gNB are collected by the target UE from a first other UE i.e. a first sidelink UE (SL-UE-1). The TI has been received by the first sidelink UE at a time instant t1. Also information of the time instant t1 will be provided to the target UE. The target UE also collects TI per gNB from a second sidelink UE (SL-UE-2) and the information of the time instant t2 when the TI has been received by the second sidelink UE. Similarly, the target UE collects TI per gNB from possible other sidelink UEs (SL-UE-K). It should be noted that it may also happen that there is only one or two SL-UEs from which the TI will be collected (i.e. k is 1 or 2, respectively).

In block 1102 the target UE corroborates aggressors' TI to obtain a CI model per gNB (each aggressor) at time T and location L i.e. the target UE's time and location. The time T may be different from the time t1, . . . tk of the helper UEs. The location L is different from the location L1, . . . Lk of the helper UEs.

In block 1104 the target UE regenerates the TX interference based on TI signal per gNB.

In block 1103 the target UE regenerates the aggressors' signals as seen at the target UE based on the TI and CI specific to the target UE and obtained by the corroboration process of block 1102 and the regenerated TX interference.

In block 1105 the target UE may clean the PRS partly or totally using the output of block 1103. The efficiency of the cleaning process may depend on how reliable the model output by the aggressor regeneration is. By partial cleaning it is meant that only a part of the aggressor's regenerated behavior (e.g., only the main regenerated path of the aggressor channel) is used to remove the interference experienced by the target UE.

In block 1106 the cleaned PRS can be used to extract and report positioning measurements.

It should be noted that the expressions each aggressor, each helper UE, etc. does not necessarily mean each and every existing aggressor (gNB), each UE etc. but mainly a determined, detected or selected set of gNBs, UEs., etc. For example, the target UE may be able to detect which gNBs are possibly causing interference to positioning reference signal(s) wherein the expression each aggressor or each gNB refers to those gNBs only.

The above-described procedures may enable spectrally efficient positioning and communications services e.g. because the interference of strong other signals may be reduced.

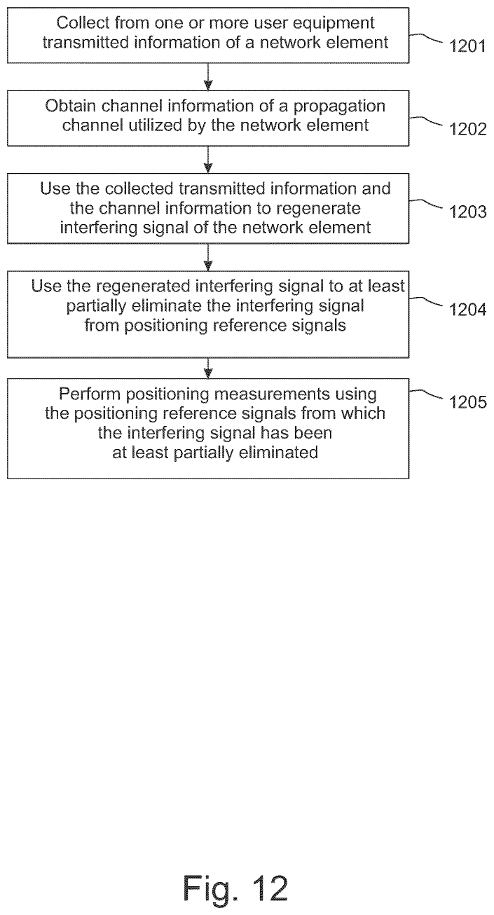

FIG. 12 shows a flow diagram of a method for the compensation of one or more signals from a network element interfering reception of positioning reference signals. The method comprises collecting 1201 by an apparatus from one or more user equipment transmitted information of a network element, obtaining 1202 information of a propagation channel utilized by the network element, using the collected transmitted information and the channel information to regenerate 1203 by the apparatus interfering signal of the network element, using the regenerated interfering signal to at least partially compensate or eliminate 1204 the interfering signal from the positioning reference signals, and performing positioning measurements 1205 by the apparatus using the positioning reference signals from which the interfering signal has been at least partially compensated or eliminated.

The network element may be a gNB, for example.

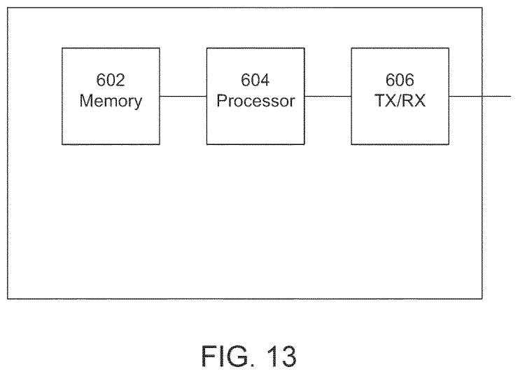

FIG. 13 illustrates an example of an apparatus in accordance with at least some embodiments of the present invention. The apparatus may be a radio device, for example a radio access node or a user radio device. The apparatus may perform one or more functionalities according to examples described herein.

The apparatus comprises a processor 602 and a transceiver 604. The processor is operatively connected to the transceiver for controlling the transceiver. The apparatus may comprise a memory 606. The memory may be operatively connected to the processor. It should be appreciated that the memory may be a separate memory or included to the processor and/or the transceiver.

According to an embodiment, the processor is configured to control the transceiver to perform one or more functionalities described according to an embodiment.

A memory may be a computer readable medium that may be non-transitory. The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs) and processors based on multi-core processor architecture, as non-limiting examples.

Embodiments may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialized circuits such as field programmable gate arrays FPGA, application specify circuits ASIC, signal processing devices and other devices. References to computer readable program code means, computer program, computer instructions, computer code etc. should be understood to express software for a programmable processor firmware such as the programmable content of a hardware device as instructions for a processor or configured or configuration settings for a fixed function device, gate array, programmable logic device, etc.

The above described example embodiments or parts of them may be implemented within a user radio device, UE, radio access device or a gNB.

In general, the various embodiments of the disclosure may be implemented in hardware or special purpose circuits or any combination thereof. While various aspects of the disclosure may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analogue and/or digital circuitry) and
(b) combinations of hardware circuits and software, such as (as applicable):
(i) a combination of analogue and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1. An apparatus comprising:
at least one processor; and
at least one memory storing instructions that, when executed by the at least one processor, cause the apparatus at least to:
determine which one or more user equipment to use to obtain channel information about a network element;
obtain from the determined user equipment transmitted information of the network element;
obtain from the determined user equipment channel information of a propagation channel between the determined user equipment and the network element;
obtain channel information of a propagation channel between the apparatus and the network element;
use the collected transmitted information and the channel information of the propagation channel between the apparatus and the network element to regenerate interfering signal of the network element observed by the apparatus;
use the regenerated interfering signal to at least partially compensate the interfering signal from positioning reference signals; and
perform positioning measurements using the positioning reference signals from which the interfering signal has been at least partially compensated.

2. The apparatus according to claim 1, wherein said at least one memory stored with computer program code thereon, the at least one memory and the computer program code configured to, with the at least one processor, cause the apparatus at least to:
obtain the channel information from one or more user equipment monitoring the propagation channel utilized by the network element.

3. The apparatus according to claim 2, wherein said at least one memory stored with computer program code thereon, the at least one memory and the computer program code configured to, with the at least one processor, cause the apparatus at least to:
obtain information of a location of the one or more user equipment and information of time the channel information was received by the one or more user equipment.

4. The apparatus according to claim 1, wherein said at least one memory stored with computer program code thereon, the at least one memory and the computer program code configured to, with the at least one processor, cause the apparatus at least to:
receive channel information from a plurality of user equipment;
convert the received channel information to a same format.

5. The apparatus according to claim 1, wherein said at least one memory stored with computer program code thereon, the at least one memory and the computer program code configured to, with the at least one processor, cause the apparatus at least to:
compute a range and angle of arrival to the other user equipment; and
adjust the channel information with respect to a location of the apparatus based on the range and angle of arrival.

6. The apparatus according to claim 5, wherein said at least one memory stored with computer program code thereon, the at least one memory and the computer program code configured to, with the at least one processor, cause the apparatus at least to:
apply a time filter to adjust a difference between a time of the apparatus and a time the channel information was obtained by the user equipment.

7. The apparatus according to claim 1, wherein said at least one memory stored with computer program code thereon, the at least one memory and the computer program code configured to, with the at least one processor, cause the apparatus at least to:
estimate channel impulse responses to the one or more user equipment;
provide the estimated channel impulse responses and the collected channel information to a machine learning block of the apparatus;
wherein the machine learning block is configured to adjust channel information to a location and a current time of the apparatus based on the estimated channel impulse responses and the collected channel information.

8. The apparatus according to claim 1, wherein said at least one memory stored with computer program code thereon, the at least one memory and the computer program code configured to, with the at least one processor, cause the apparatus at least to:
extract a reference signal for a sidelink signal related to the user equipment; and
provide the extracted reference signal to the machine learning block of the apparatus,
wherein the machine learning block is configured to adjust channel information to a location and a current time of the apparatus based on the extracted reference signal and the collected channel information.

9. The apparatus according to claim 7, wherein the machine learning block is further configured to:
superimpose the adjusted channel information; and
prune the superimposed channel information.

10. The apparatus according to claim 7, wherein the machine learning block is further configured to:
reconstruct the observed interfering signal; and
cancel the reconstructed interfering signal from the positioning reference signals.

11. The apparatus according to claim 1, wherein the channel information includes at least one of the following:
the decoded signals,
the channel state information related to those signals,
information about how the signal is delayed and rotated by reflectors in a field,
information about how the signal is attenuated with a distance.

12. A method, comprising:
determining which one or more user equipment to use to obtain channel information about a network element;
obtaining from the determined user equipment transmitted information of a network element;
obtaining from the determined user equipment channel information of a propagation channel between the determined user equipment and the network element;
obtaining channel information of a propagation channel between an apparatus and the network element;
using the collected transmitted information and the channel information of the propagation channel between the apparatus and the network element to regenerate interfering signal of the network element observed by the apparatus;
using the regenerated interfering signal to at least partially compensate the interfering signal from positioning reference signals; and
performing positioning measurements using the positioning reference signals from which the interfering signal has been at least partially compensated.

13. The method according to claim 12, comprising:
obtaining the channel information from one or more user equipment monitoring the propagation channel utilized by the network element.

14. The method according to claim 13, comprising:
obtaining information of a location of the one or more user equipment and information of time the channel information was received by the one or more user equipment.

15. The method according to claim 12, comprising:
receiving channel information from a plurality of user equipment;
convert the received channel information to a same format.

16. The method according to claim 12, comprising:
computing a range and angle of arrival to the other user equipment; and
adjusting the channel information with respect to a location of the apparatus based on the range and angle of arrival.

17. The method according to claim 16, comprising:
applying a time filter to adjust a difference between a time of the apparatus and a time the channel information was obtained by the user equipment.

18. The method according to claim 12, comprising:
estimating channel impulse responses to the one or more user equipment;
providing the estimated channel impulse responses and the collected channel information to a machine learning block;
using the machine learning block to adjust channel information to a location and a current time of the apparatus based on the estimated channel impulse responses and the collected channel information.

19. The method according to claim 12, comprising:
extracting a reference signal for a sidelink signal related to the user equipment; and
obtaining the extracted reference signal; and
using a machine learning block to adjust channel information to a location and a current time of the apparatus based on the extracted reference signal and the collected channel information.

20. The method according to claim 18, comprising using the machine learning block to:
superimpose the adjusted channel information; and
prune the superimposed channel information.

21-30. (canceled)
